(19) United States
(12) Patent Application Publication
(10) Pub. No.: US 2026/0118495 A1
(43) Pub. Date: Apr. 30, 2026

(54) ULTRA WIDEBAND (UWB) RADAR INTEGRATED FINE TIMING MEASUREMENT (FTM) BASED INDOOR LOCATIONING

(71) Applicant: Cisco Technology, Inc., San Jose, CA (US)

(72) Inventors: Rabe Arshad, San Jose, CA (US); Ardalan Alizadeh, Milpitas, CA (US); Peiman Amini, Fremont, CA (US); Audrey Yazdan, Richfield, OH (US)

(21) Appl. No.: 19/003,139

(22) Filed: Dec. 27, 2024

Related U.S. Application Data
(60) Provisional application No. 63/615,245, filed on Dec. 27, 2023.

(51) Int. Cl. G01S 13/46; G01S 7/28; G01S 13/02

(52) U.S. Cl. CPC G01S 13/46; G01S 7/2806; G01S 13/0209; G01S 2205/02

(57) ABSTRACT

Ultra Wideband (UWB) radar integrated Fine Timing Measurement (FTM) based indoor locationing may be provided. First, a computing device may detect that Non Line of Sight (NLOS) conditions exist based on a spatial layout derived using the UWB radar. Next, the computing device may determine a delay error, in response detecting that the NLOS conditions exist, based on the spatial layout. Then the computing device may adjust FTM times using the delay error.

### RELATED APPLICATION TECHNICAL FIELD

Under provisions of 35 U.S.C. § 119 (e), Applicant claims the benefit of U.S. Provisional Application No. 63/615,245 filed Dec. 27, 2023, which is incorporated herein by reference.

### TECHNICAL FIELD

The present disclosure relates generally to providing Ultra Wideband (UWB) radar integrated Fine Timing Measurement (FTM) based Indoor locationing.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for providing Ultra Wideband (UWB) radar integrated Fine Timing Measurement (FTM) based Indoor locationing;

FIG. 2 is a flow chart of a method for providing UWB radar integrated FTM based Indoor locationing;

FIG. 3 is a state diagram of a method for providing UWB radar integrated FTM based Indoor locationing; and

FIG. 4 is a block diagram of a computing device.

### DETAILED DESCRIPTION

### Overview

Ultra Wideband (UWB) radar integrated Fine Timing Measurement (FTM) based indoor locationing may be provided. First, a computing device may detect that Non Line of Sight (NLOS) conditions exist based on a spatial layout derived using the UWB radar. Next, the computing device may determine a delay error, in response detecting that the NLOS conditions exist, based on the spatial layout. Then the computing device may adjust FTM times using the delay error.

Both the foregoing overview and the following example embodiments are examples and explanatory only and should not be considered to restrict the disclosure's scope, as described and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Access Points (APs) may use Wi-Fi Fine Timing Measurement (FTM) to determine client device positions' as well as AP to AP ranging to perform AP placement automatically. This feature may be essential for several indoor applications where precise location tracking of client devices may be required.

There is often no direct Line-of-Sight (LOS) between the AP and the client devices, resulting in a Non-Line-of-Sight (NLOS) ranging situation. In NLOS conditions, signals may face obstructions and delays that may be several nanoseconds long. These delays may reduce the localization accuracy and precision of the FTM. This NLOS issue may also affect the AP auto-location feature, where APs use FTM ranging to determine their relative positions to each other. To address this, each AP may need a unique calibration based on its environment. Reliable detection of these channel conditions, especially the presence of NLOS, may be crucial to improve localization accuracy in challenging environments.

Embodiments of the disclosure may integrate Ultra Wideband (UWB) radar capabilities into Wi-Fi7 APs for example. This integration may offer a refined analysis of the environment, enhancing the precision of distance estimations. By leveraging UWB radar's spatial insights and FTM's temporal data, embodiments of the disclosure may provide a robust framework for accurate indoor positioning, especially in environments prone to NLOS conditions. Consequently, embodiments of the disclosure may leverage the UWB radar capability into the FTM ranging process by detecting a NLOS error and compensate it accordingly.

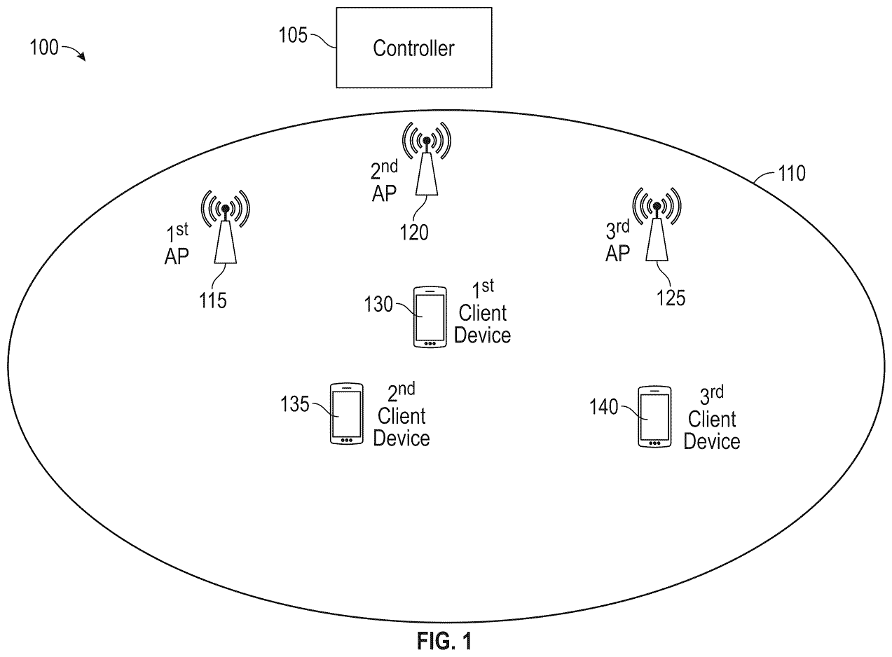

FIG. 1 shows an operating environment 100 for providing Ultra Wideband (UWB) radar integrated Fine Timing Measurement (FTM) based Indoor locationing. As shown in FIG. 1, operating environment 100 may comprise a controller 105 and a coverage environment 110. Coverage environment 110 may comprise, but is not limited to, a Wireless Local Area Network (WLAN) comprising a plurality of Access Points (APs) that may provide wireless network access (e.g., access to the WLAN for client devices). The plurality of APs may comprise a first AP 115, a second AP 120, a third AP 125. The plurality of APs may provide wireless network access to a plurality of client devices as they move within coverage environment 110. The plurality of client devices may comprise, but are not limited to, a first client device 130, a second client device 135, and a third client device 140. Ones of the plurality of client devices may comprise, but are not limited to, a smart phone, a personal computer, a tablet device, a mobile device, a telephone, a remote control device, a set-top box, a digital video recorder, an Internet-of-Things (IoT) device, a network computer, a router, Virtual Reality (VR)/Augmented Reality (AR) devices, or other similar microcomputer-based device. Each of the plurality of APs may be compatible with specification standards such as, but not limited to, the Institute of Electrical and Electronics Engineers (IEEE) 802.11 specification standard for example.

The plurality of APs and the plurality of client devices may use Multi Link Operation (MLO) where they simultaneously transmit and receive across different bands and channels by establishing two or more links to two or more AP radios. These bands may comprise, but are not limited the 2 GHz band, the 5 GHz band, the 6 GHZ band, and the 60 GHz band. The two or more links on any given one of the plurality of client devices may be made with any one AP or with any combination of the APs.

The plurality of APs and the plurality of client devices may also have a UWB radio that may use UWB radio technology using a very low energy level for short-range, high-bandwidth communications over a large portion of the radio spectrum. UWB may transmit information across a wide bandwidth (e.g., >500 MHz). This may allow for the transmission of a large amount of signal energy without interfering with conventional narrowband and carrier wave transmission in the same frequency band. Regulatory limits in many countries may allow for this efficient use of radio bandwidth, and enable high-data-rate personal area network (PAN) wireless connectivity, longer-range low-data-rate applications, and the transparent co-existence of radar and imaging systems with existing communications systems.

Controller 105 may comprise a Wireless Local Area Network controller (WLC) and may provision and control coverage environment 110 (e.g., a WLAN). Controller 105 may allow first client device 130, second client device 135, and third client device 140 to join coverage environment 110. In some embodiments of the disclosure, controller 105 may be implemented by a Digital Network Architecture Center (DNAC) controller (i.e., a Software-Defined Network (SDN) controller) that may configure information for coverage environment 110 in order to provide UWB radar integrated FTM based Indoor locationing.

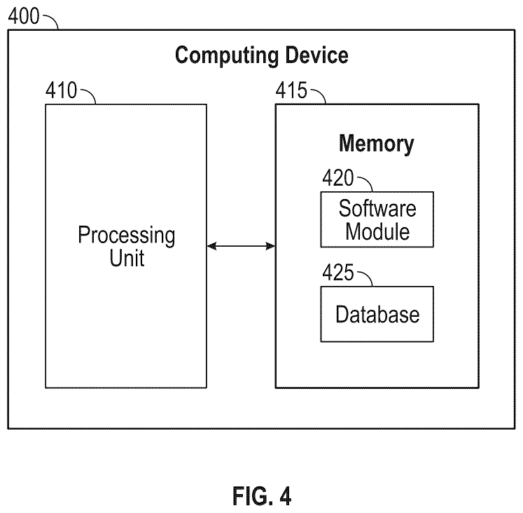

The elements described above of operating environment 100 (e.g., controller 105, first AP 115, second AP 120, third AP 125, first client device 130, second client device 135, or third client device 140) may be practiced in hardware and/or in software (including firmware, resident software, micro-code, etc.) or in any other circuits or systems. The elements of operating environment 100 may be practiced in electrical circuits comprising discrete electronic elements, packaged or integrated electronic chips containing logic gates, a circuit utilizing a microprocessor, or on a single chip containing electronic elements or microprocessors. Furthermore, the elements of operating environment 100 may also be practiced using other technologies capable of performing logical operations such as, for example, AND, OR, and NOT, including but not limited to, mechanical, optical, fluidic, and quantum technologies. As described in greater detail below with respect to FIG. 4, the elements of operating environment 100 may be practiced in a computing device 400.

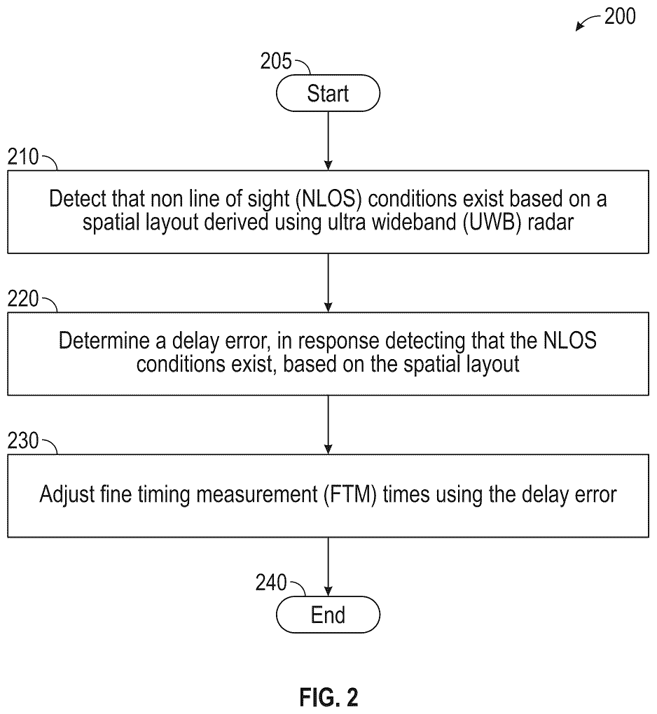

FIG. 2 is a flow chart setting forth the general stages involved in a method 200 consistent with embodiments of the disclosure providing UWB radar integrated FTM based indoor locationing. Method 200 may be implemented using computing device 400 as described in more detail below with respect to FIG. 4. Computing device 400 may be embodied by first AP 115 (e.g., a responder) or first client device 130 may (e.g., an initiator) for example. Ways to implement the stages of method 200 will be described in greater detail below.

Method 200 may begin at starting block 205 and proceed to stage 210 where computing device 400 may detect that Non Line of Sight (NLOS) conditions exist based on a spatial layout derived using Ultra Wideband (UWB) radar. For example, this may be accomplished by, but not limited to, enhanced environment perception, temporal and spatial synchronization, or advanced multipath resolution as described below.

### Enhanced Environment Perception

The UWB radar system, operating at 500 MHz bandwidth as an impulse radio, may provide a high-resolution spatial profile of the environment, detecting obstacles and potential reflection points. On the other hand, the FTM system, based on Wi-Fi RTT, may offer a Channel Impulse Response (CIR) that may give information about the time of flight of the signal, and thus, the distance. In addition, IEEE 802.11az may allow tracking the Angle-of-Arrival (AoA) from the client device, and hence the client device's approximate position may be determined.

While the two systems may have distinct CIRs, insights from the UWB radar's spatial profile may be used to anticipate potential obstructions or reflections that might affect the FTM measurements. Embodiments of the disclosure may correlate the CIR data from UWB with the FTM's CIR. The process better interprets and adjusts the FTM-based distance estimations, particularly in scenarios with potential NLOS conditions.

The ranges of FTM and UWB radar may vary depending on environmental conditions. FTM's range may extend beyond 30 meters in some scenarios, particularly in ideal conditions with clear LOS conditions. On the other hand, UWB radar, known for its high precision, often offers a range of up to 18 meters, although this range may vary depending on the specific frequency bands used.

The effective range of both FTM and UWB radar may be influenced by several factors, including the power of the transmitters, the sensitivity of the receivers, the presence of obstacles, and the frequency bands employed. Therefore, when implementing a system that combines both technologies, it may be crucial to consider the overlapping range where both are capable of functioning optimally. For longer ranges, such as 20 meters or beyond, FTM data may become indispensable for NLOS detection.

In another embodiment, the correlation between the Received Signal Strength Indicator (RSSI) and distance may be forced to be close to −1 for each channel. It may be noted that the offset values may vary per channel number because the Channel State Information (CSI) responses may differ significantly across channels. By carefully fine-tuning these channel-specific offset parameters, we may enhance the accuracy of indoor positioning and overcome challenges associated with NLOS conditions in complex environments.

### Temporal and Spatial Synchronization

Embodiments of the disclosure may provide a synchronization process that may combine the time-stamped data from UWB radar and FTM measurements. Given that UWB may offer a high temporal resolution due to its wide bandwidth, this synchronization may ensure that the CIR derived from FTM may be cross-referenced with the spatial data from UWB radar. This approach may involve continuously comparing the CIR from FTM with spatial maps from UWB to ensure they are aligned and consistent.

This process may ensure that the data from both systems is temporally aligned. Meaning that if the UWB radar scans the environment and detects a certain spatial layout at time t, the FTM measurements taken around time t should be aligned with that layout. For instance, consider the case where the UWB radar detects a new obstruction at time t. If a client device also takes FTM measurements at roughly time t, embodiments may ensure that the FTM-derived distance takes into account that new obstruction, as it might cause signal reflections or delays.

Further, using multiple antennas with UWB radar and beam sweeping, the obstacles/walls in all directions may be scanned. Thus, using AoA information offered by Wi-Fi, spatial synchronization between UWB and Wi-Fi FTM may be achieved. For instance, consider there is a wall on one side of the AP and there is a client sitting behind it. Through spatial synchronization, embodiments may ensure that the FTM measurements are adjusted for that client only.

### Advanced Multipath Resolution

Initially, during a calibration phase, UWB radar may establish a foundational spatial map by scanning known fixed points or other APs. Simultaneously, the FTM system may determine baseline CIR measurements to these points. As the environment evolves or as clients move, the system may continuously cross-references subsequent UWB scans with real-time FTM CIR data. Any significant deviation in the CIR from the baseline, such as the emergence of new peaks or changes in expected peaks' amplitude or delay, may be cross-checked against the UWB spatial map. This dual-checking mechanism may provide context to whether such deviations are due to reflections, obstructions, or direct paths.

In this process, rather than merging UWB and FTM data, they are intelligently cross-referenced. Peaks in the CIR that align with obstructions identified by the UWB radar may be recognized as reflections. These identified reflections may then be given less weight or de-emphasized when calculating distances, ensuring more accurate distance estimations in challenging environments.

From stage 210, where computing device 400 detects that the Non NLOS conditions exist based on the spatial layout derived using the Ultra Wideband (UWB) radar, method 200 may advance to stage 220 where computing device 400 may determine a delay error, in response detecting that the NLOS conditions exist, based on the spatial layout. For example, the challenge with NLOS conditions may not just be in detecting them, but also in quantifying and correcting the errors they introduce in distance estimations. UWB radar's detailed spatial insights may play a pivotal role in this correction.

Upon detecting potential NLOS conditions using the stages described above, embodiments of the disclosure may move to a compensation phase. The spatial layout provided by UWB radar, including details about obstacles and their potential reflective surfaces, may help model the potential signal paths the Wi-Fi signal might have taken in these NLOS conditions. By understanding these potential paths and their lengths, embodiments of the disclosure may estimate the additional delay or “error” the Wi-Fi signal may have incurred due to reflections or obstructions.

Once computing device 400 determines the delay error, in response detecting that the NLOS conditions exist, based on the spatial layout in stage 220, method 200 may continue to stage 230 where computing device 400 may adjust FTM times using the delay error (e.g., d). For example, using this estimated error, embodiments of the disclosure may then adjust the FTM-derived distances. If, for example, it may be determined that a reflection caused an additional delay (d) of 5 nanoseconds, this delay may be added to the FTM measurement to give a more accurate estimation of the true distance for all the measurements.

To ensure continued accuracy, this compensation may be dynamic and adjusts as the environment changes or as new obstructions come into play. The continuous feedback from the UWB radar's spatial scans may ensure that the FTM error compensation remains relevant and precise, even in dynamically changing environments.

In another embodiment, an infrastructure administrator may input the FTM measurement accuracy behind a wall. This parameter may be generalized for an entire building due to a similar construction environment. Because UWB radar may identify objects behind multiple walls, the correction factor in FTM may be applied based on the number of walls. Once computing device 400 adjusts the FTM times using the delay error in stage 230, method 200 may then end at stage 240.

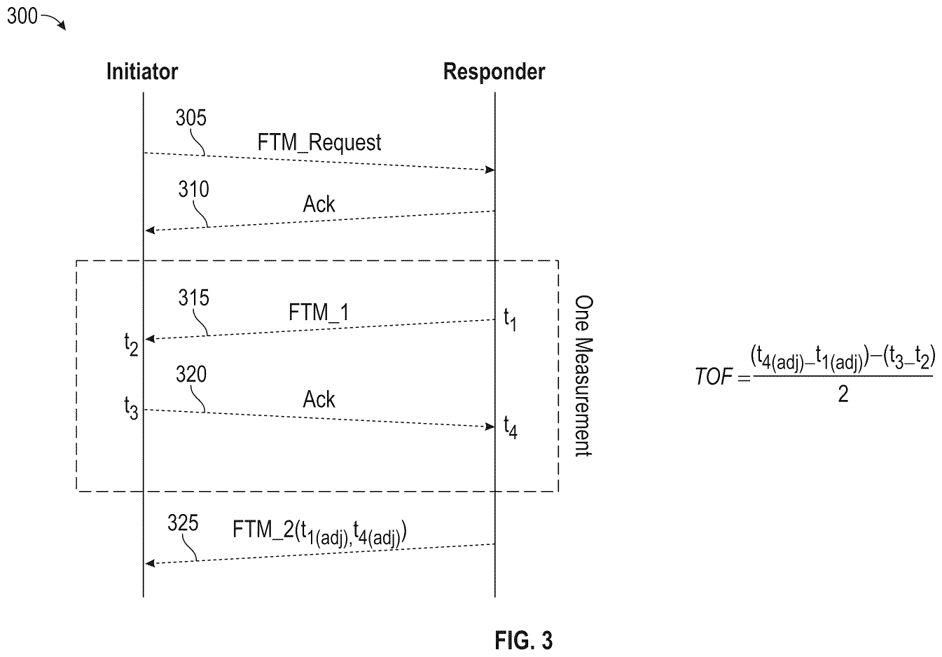

FIG. 3 is a state diagram of a method 300 for providing UWB radar integrated FTM based Indoor locationing. The initiator (e.g., first client device 130) may send an FTM request (stage 305) to the responder (e.g., first AP 115) that may acknowledge in return (stage 310). The responder may send an FTM message (stage 315) and may record the time of transmission (i.e., t₁). The initiator may record the timestamps (i.e., t₂ and t₃) upon receiving the message and sending the acknowledgment (stage 320).

The responder may record the time when the acknowledgment is received (i.e., t₄). Adjustments comprising the delay error (e.g., d) may be applied to the t₁ and t₄ timestamps based on the CIR of the UWB and the CIR of the Wi-Fi as described above.

$$\begin{matrix}{t}_{1 ( adj )} = {t}_{1} + d \\ {t}_{4 ( adj )} = {t}_{4} + d\end{matrix}$$

The responder may transmit to the initiator another FTM message (stage 325) including the adjusted t₁ and t₄. The responder may use adjusted t₁ and t₄ to calculate the Time-of-Flight (TOF) and thus it's position.

FIG. 4 shows computing device 400. As shown in FIG. 4, computing device 400 may include a processing unit 410 and a memory unit 415. Memory unit 415 may include a software module 420 and a database 425. While executing on processing unit 410, software module 420 may perform, for example, processes for providing UWB radar integrated FTM based indoor locationing as described above with respect to FIG. 2 and FIG. 3. Computing device 400, for example, may provide an operating environment for controller 105, first AP 115, second AP 120, third AP 125, first client device 130, second client device 135, or third client device 140. Controller 105, first AP 115, second AP 120, third AP 125, first client device 130, second client device 135, or third client device 140 may operate in other environments and are not limited to computing device 400.

Computing device 400 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 400 may comprise any computer operating environment, such as hand-held devices, multiprocessor systems, microprocessor-based or programmable sender electronic devices, minicomputers, mainframe computers, and the like. Computing device 400 may also be practiced in distributed computing environments where tasks are performed by remote processing devices. The aforementioned systems and devices are examples, and computing device 400 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 400 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

What is claimed is:

1. A method comprising:
detecting, by a computing device, that Non Line of Sight (NLOS) conditions exist based on a spatial layout derived using Ultra Wideband (UWB) radar;
determining a delay error, in response detecting that the NLOS conditions exist, based on the spatial layout; and
adjusting Fine Timing Measurement (FTM) times using the delay error.

2. The method of claim 1, wherein detecting that the NLOS conditions exist based on the spatial layout derived using the UWB radar comprises correlating a UWB Channel Impulse Response (CIR) and a Fine Timing Measurement (FTM) CIR.

3. The method of claim 1, wherein detecting that the NLOS conditions exist based on the spatial layout derived using the UWB radar comprises forcing a correlation between a Received Signal Strength Indicator (RSSI) and a distance to be approximately −1 for each channel.

4. The method of claim 1, wherein detecting that the NLOS conditions exist based on the spatial layout derived using the UWB radar comprises synchronizing UWB time-stamped data and FTM time-stamped data.

5. The method of claim 1, wherein detecting that the NLOS conditions exist based on the spatial layout derived using the UWB radar comprises synchronizing UWB time-stamped data and FTM time-stamped data using Angle-of-Arrival (AOA) information.

6. The method of claim 1, wherein detecting that the NLOS conditions exist based on the spatial layout derived using the UWB radar comprises, during a calibration phase, the UWB radar establishing a foundational spatial map by scanning known fixed points while FTM baseline CIR measurements are determined to these known fixed points.

7. The method of claim 1, wherein determining the delay error comprises using a number of walls value obtained from the UWB radar.

8. A system comprising:
a memory storage; and
a processing unit coupled to the memory storage, wherein the processing unit is operative to:
detect that Non Line of Sight (NLOS) conditions exist based on a spatial layout derived using Ultra Wideband (UWB) radar;
determine a delay error, in response detecting that the NLOS conditions exist, based on the spatial layout; and
adjust Fine Timing Measurement (FTM) times using the delay error.

9. The system of claim 8, wherein the processing unit being operative to detect that the NLOS conditions exist based on the spatial layout derived using the UWB radar comprises the processing unit being operative to correlate a UWB Channel Impulse Response (CIR) and a Fine Timing Measurement (FTM) CIR.

10. The system of claim 8, wherein the processing unit being operative to detect that the NLOS conditions exist based on the spatial layout derived using the UWB radar comprises the processing unit being operative to force a correlation between a Received Signal Strength Indicator (RSSI) and a distance to be approximately −1 for each channel.

11. The system of claim 8, wherein the processing unit being operative to detect that the NLOS conditions exist based on the spatial layout derived using the UWB radar comprises the processing unit being operative to synchronize UWB time-stamped data and FTM time-stamped data.

12. The system of claim 8, wherein the processing unit being operative to detect that the NLOS conditions exist based on the spatial layout derived using the UWB radar comprises the processing unit being operative to synchronize UWB time-stamped data and FTM time-stamped data using Angle-of-Arrival (AOA) information.

13. The system of claim 8, wherein the processing unit being operative to detect that the NLOS conditions exist based on the spatial layout derived using the UWB radar comprises the processing unit being operative to, during a calibration phase, the UWB radar establish a foundational spatial map by scanning known fixed points while FTM baseline CIR measurements are determined to these known fixed points.

14. A non-transitory computer-readable medium that stores a set of instructions which when executed perform a method executed by the set of instructions comprising:
detecting, by a computing device, that Non Line of Sight (NLOS) conditions exist based on a spatial layout derived using Ultra Wideband (UWB) radar;
determining a delay error, in response detecting that the NLOS conditions exist, based on the spatial layout; and
adjusting Fine Timing Measurement (FTM) times using the delay error.

15. The non-transitory computer-readable medium of claim 14, wherein detecting that the NLOS conditions exist based on the spatial layout derived using the UWB radar comprises correlating a UWB Channel Impulse Response (CIR) and a Fine Timing Measurement (FTM) CIR.

16. The non-transitory computer-readable medium of claim 14, wherein detecting that the NLOS conditions exist based on the spatial layout derived using the UWB radar comprises forcing a correlation between a Received Signal Strength Indicator (RSSI) and a distance to be approximately −1 for each channel.

17. The non-transitory computer-readable medium of claim 14, wherein detecting that the NLOS conditions exist based on the spatial layout derived using the UWB radar comprises synchronizing UWB time-stamped data and FTM time-stamped data.

18. The non-transitory computer-readable medium of claim 14, wherein detecting that the NLOS conditions exist based on the spatial layout derived using the UWB radar comprises synchronizing UWB time-stamped data and FTM time-stamped data using Angle-of-Arrival (AOA) information.

19. The non-transitory computer-readable medium of claim 14, wherein detecting that the NLOS conditions exist based on the spatial layout derived using the UWB radar comprises, during a calibration phase, the UWB radar establishing a foundational spatial map by scanning known fixed points while FTM baseline CIR measurements are determined to these known fixed points.

20. The non-transitory computer-readable medium of claim 14, wherein determining the delay error comprises using a number of walls value obtained from the UWB radar.
